(19) United States
(12) Patent Application Publication
(10) Pub. No.: US 2002/0189445 A1
(43) Pub. Date: Dec. 19, 2002

(54) Process for the wellbore separation of CO2 from hydrocarbon gas

(76) Inventors: Stephen J. Miller, San Francisco, CA (US); William John Koros, Atlanta, GA (US); De Quang Vu, Richmond, CA (US)

Correspondence Address: Chevron Texaco Corporation, 2613 Camino Ramon, Law Department, Intellectual Property Unit, San Ramon, CA, 94583, US

(21) Appl. No.: 09/841,600

(22) Filed: Apr. 25, 2001

(51) Int. Cl. B01D 53/22

(52) U.S. Cl. 95/51

(57) ABSTRACT

Carbon dioxide (CO2) is separated from natural gas in a downhole environment. An asymmetric hollow-carbon fiber membrane is positioned in a production string within a wellhole through which a CO2-containing natural gas is being conducted. The carbon fiber comprises a partial carbonization product of a hollow filament including an aromatic imide polymer material. The carbon membrane is at least 90 weight percent carbon, and has a dense fiber layer located in the outside surface portion of the membrane and a porous base fiber layer contiguous with the dense layer and located in the inside portion of the membrane. The natural gas is passed through the membrane at a pressure of at least about 200 psia.

### RELATED APPLICATIONS

This invention is related to that described in copending application Ser. No. 09/437,993 filed Nov. 10, 1999.

### FIELD OF THE INVENTION

The invention relates to recovery of hydrocarbon gas from a wellbore, and more particularly, the invention relates to membrane technology for the downhole separation of contaminants from hydrocarbon gas, especially to a process for using a carbon membrane to separate CO₂ from natural gas within a wellbore.

### BACKGROUND OF THE INVENTION AND BRIEF DESCRIPTION OF THE RELATED ART

Hydrocarbon gases have been recovered from underground wellbores for over a hundred years. The recovery technology generally involves drilling a wellbore into a hydrocarbon gas formation and withdrawing the hydrocarbon gas under reservoir pressure or by artificial lifting.

The current recovery technology involves removing from the wellbore the hydrocarbon gas together with any liquid and gas contaminants which are present, and separating the contaminants from the hydrocarbon gas above ground. This above-ground separation of contaminants from the hydrocarbon gas is costly. Disposal of the removed contaminants from the hydrocarbon gas is costly and may present environmental problems. The contaminants which may be produced include gases, such as carbon dioxide, nitrogen, water vapor, hydrogen sulfide, helium, and other traces gases and liquids such as water, heavy hydrocarbons, and others.

The contaminants which are brought to the surface and separated from the hydrocarbon gas are released to the atmosphere or otherwise disposed of adding additional expense to the process. Due to environmental concerns about the release of greenhouse gases, many countries are placing greater and greater limitations on emission of byproduct gases to the atmosphere. For example, some countries now assess a tax on carbon dioxide emissions.

Accordingly, it would be highly desirable to maintain some or all of the contaminant materials, such as carbon dioxide, within the wellbore and/or selectively separate the contaminants in the wellbore for reinjection, removal, or other processing.

It has been proposed to position a filter downhole for separating from hydrocarbons. For example, U.S. Pat. No. 6,015,011 describes a downhole hydrocarbon separating using one or more permeable filters which selectively permit the migration of oil or natural gas through the filters and out of the well while leaving the contaminants behind within the wellbore. Among the types of filters proposed in that patent are membrane filters, but there is no mention of materials of which the membrane should be made.

It is known that certain carbon membranes are particularly useful for the separation of fluids, especially gases such as oxygen and nitrogen. The carbon membranes may be symmetrical, asymmetrical, single-component or composite. However, carbon membranes have the major problem of being vulnerable to fouling due to impurities in various hydrocarbon compounds. For example, certain hydrocarbon impurities cause selective fouling of the carbon membrane resulting in reduced selectivity. Such impurities intolerance is reported in the scientific literature, e.g., one study showed that, for O₂/N₂ separation, a carbon molecular sieve (“CMS”) membrane performance deteriorated rapidly with n hexane saturated air feed, Carbon, 32 (1427), and another study showed that, with a mixed feed gas of 50/50 H₂/CH₄ with toluene vapor at low pressures (150 psia), fluxes were reduced by 15 to 20%, and the H₂/CH₄ selectivity was reduced by 14%. (J. Membrane Sci., 160, 179 186).

Even small amounts of such hydrocarbons can significantly impair the performance of the membrane. Impurities may be removed from the fluid by various filtration, separation or extraction techniques. These measures may involve the use of large, expensive equipment and are often not successful.

Another deficiency of known carbon membranes is an inability to perform well with high pressure feeds. The feed, e.g., for a natural gas CO₂ separation process is typically directly from the well. It is desirable to avoid pressure loss through the purification process. Reducing the pressure to satisfy membrane pressure limits is economically disadvantageous. If pressure is reduced, expensive compressors may be required to increase the pressure of the stream for passage through an export pipeline.

There are several patents describing processes for producing carbon membranes (both asymmetric hollow “filamentary” membranes and flat sheets) and applications for various gas separations. These patents teach separations of O₂/N₂, H₂/CH₄, CO₂/N₂, or other separations. See, e.g., U.S. Pat. No. 4,685,940 for a Separation Device, U.S. Pat. No. 5,288,304 for Composite Carbon Fluid Separation Membranes, and EP Patent No. 459,623 for Asymmetric Hollow Filamentary Carbon Membrane And Process For Producing Same, each of which being incorporated herein by reference in their entireties. None of these patents teaches CO₂/CH₄ separation, especially at high pressure or in the presence of impurities.

### SUMMARY OF THE INVENTION

It would, therefore, be desirable to enable carbon membranes to separate CO₂ from natural gas in a wellbore (i.e., downhole) with a high degree of selectivity even at high pressures, while being highly resistant to fouling.

The invention relates to a process for the downhole separation of CO₂ from natural gas. The process comprises the steps of:

conducting a CO₂-containing natural gas within a production string including a downhole asymmetric filamentary carbon membrane system comprising a partial carbonization product of hollow fiber, the fiber comprising an aromatic imide polymer material, the material comprising at least 90 weight percent carbon, the membrane system having a dense layer located in an outside portion of the membrane system and a porous base layer contiguous with the dense layer and located in an inside portion of the membrane system; and

passing the CO₂-containing natural gas through the membrane system at a pressure of at least about 200 psia to cause the CO₂ to pass into the fiber interior and form a CO₂-enriched permeate therein, and a CO₂-depleted retentate outside of the fiber.

### BRIEF DESCRIPTION OF THE DRAWINGS

The objects and advantages of the invention will become apparent from the following detailed description of preferred embodiments thereof in connection with the accompanying drawings in which like numerals designate like elements and in which:

FIG. 1 schematically depicts a production string for performing a CO₂ separation process in accordance with the present invention.

FIG. 2 depicts, in one embodiment of the invention, apparatus for the pyrolysis aspect of the invention.

FIG. 3 depicts, in one embodiment of the invention, apparatus for forming one or more pyrolyzed CMS's into a separations module.

FIG. 4 depicts, in one embodiment of the invention, a schematic diagram of the process of the invention.

### DETAILED DESCRIPTION OF PREFERRED EMBODIMENTS OF THE INVENTION

A) Production String:

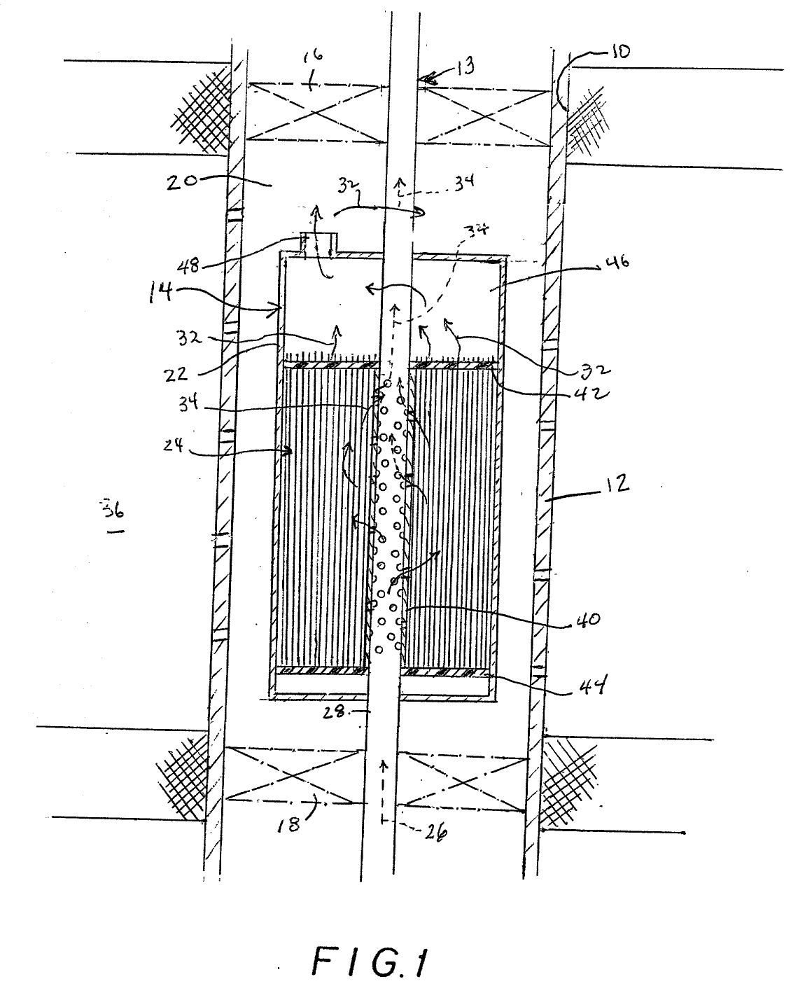

FIG. 1 illustrates a wellbore 10 having a well casing 12, and a production string 13 positioned within the well casing, the production string including a gas separation system 14.

The gas separation system 14 includes a housing 22 in which is disposed a tubular hollow fiber membrane system 24 which contains a bundle of fibers in a manner described below. The membrane system functions to permeate CO₂ out of a hydrocarbon gas mixture 26 being conducted through the production string 13 from a production zone (not shown).

The hydrocarbon gas mixture 26 exits a center tube 28 of the production string 13 through perforations 30 in the tube that are surrounded by the membrane system 24. While passing through the membrane system 24, the mixture is divided into a CO₂-enriched permeate 32 and a CO₂-depleted retentate 34, in a manner to be explained. The Co₂-depleted retentate is conducted upwardly to ground level. The CO₂-enriched permeate 32 can be handled in various ways. For example, the permeate 32 can be simply discharged out of the annulus 20. Alternatively, a section of the annulus CO₂-enriched permeate through perforations in the wellbore casing 12 to a surrounding disposal formation 36. Another alternative measure involves piping the CO₂-enriched permeate to a separate disposal formation. Instead of being discharged directly into the annulus 20, the CO₂-enriched permeate 32 could be conducted to another membrane for further purification before being discharged below the ground surface.

Although the embodiment of FIG. 1 has been illustrated with a single gas separation system 14, additional series-arranged systems may be provided for the removal of the same or additional contaminants, as needed.

A process for making the membrane system 24 will be described in detail below.

B) Methodology of Formation of Carbon Membranes

a) The Fiber

U.S. Pat. No. 5,288,304 teaches generally a method for preparation of carbon molecular sieve membranes. That disclosure is incorporated herein by reference in its entirety. A polymeric fiber is the starting material for preparation of the carbon molecular sieve membranes. The polymeric fiber used is any suitable polyimide spun by any conventional method, e.g., spun from a polymer solution through a spinneret. The polyimide is derived from a reaction of any suitable reactants. In one preferred embodiment of the invention, the reactants are three monomers: 2,4,6 trimethyl 1,3 phenylene diamine, 5,5 [2,2,2 trifluoro1(trifluoromethyl)ethylidene] 1,3 isobenzofurandion, and 3,3′,4,4′ biphenyl tetra carboxylic acid dianhydride. Its chemical structure is shown below.

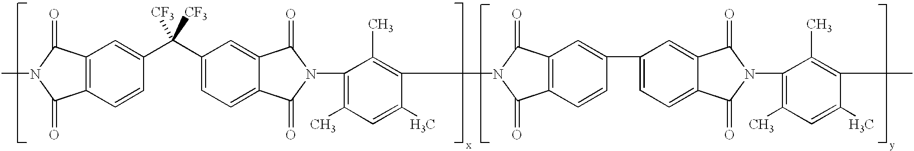

Such fibers were obtained from E. I. du Pont de Nemours and Company and L'Air Liquide S.A. This polymer is taught in U.S. Pat. No. 5,234,471, which disclosure is incorporated by reference in its entirety. Without limiting the invention, such commercially available polymeric fibers typically have an outer diameter of about 250 micron and an inner diameter of about 160 micron. Individual fibers of a desired length are then pyrolyzed.

b) Pyrolysis of the Fiber

The fibers to be pyrolyzed are placed on a piece of stainless steel mesh and held in place by any conventional means, e.g., by wrapping a length of bus wire around the mesh and fibers. The mesh support and fibers are then placed in any suitable pyrolysis zone, e.g., in quartz tube of which sits in a Thermcraft tube furnace. The tube is substantially centered so that the entire fiber length is within the effective heating zone. The pressure during pyrolysis is from about 0.01 mm Hg to about 0.10 mm Hg. In one preferred embodiment, the system is evacuated until the pressure is 0.05 mm Hg or lower.

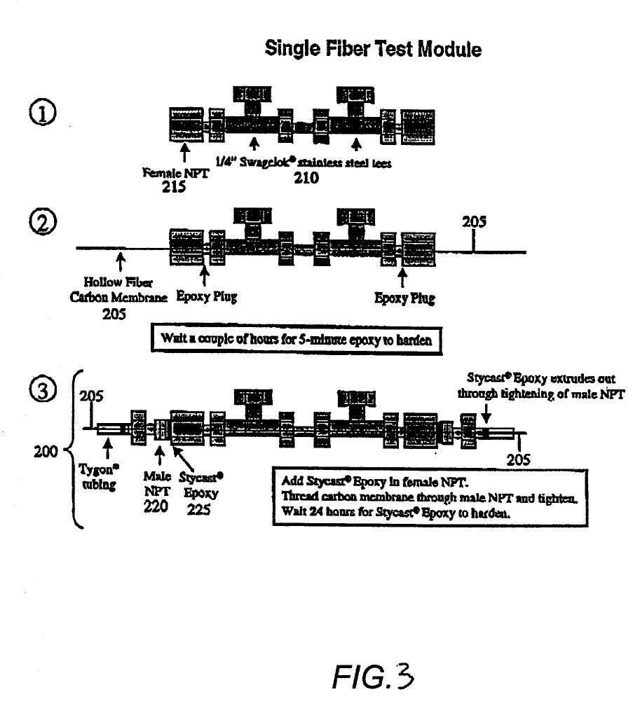

The pyrolysis follows a heating cycle as follows: The fibers are carbonized to a specific structural morphology and carbon composition by controlling the heating protocol with three critical variables: temperature set points, rate at which these temperature set points are reached (“ramp”), and the amount of time maintained at these set points (“soak”). The pyrolysis can be operated with final temperature set points up to about 1000 C., preferably up to at least 500 C. as the final set point temperature, and more preferably from about 550 C. to about 800 C. as the final set point temperature. The pyrolysis “soak” times can be performed with times up to about 10 hours, preferably at least about 1 hour, and more preferably from about 2 hours to about 8 hours. In one preferred embodiment, the heating cycle is initiated with the following protocol (where SP=set point): start at SPO which is about 50 C. then heated to SP1 which is about 250 C. at a rate of about 13.3 C./min, then heated to SP2 which is about 535 C. at a rate of about 3.85 C./min, then heated to SP3 which is about 550 C. at a rate of about 0.25 C./min; the SP3 which is about 550 C. is maintained for about 2 hours. After the heating cycle is complete, the system is typically allowed to cool under vacuum. The carbon membranes are removed once the system temperature drops below about 40 C. One suitable arrangement of equipment for the pyrolysis step in the process is shown in FIG. 3, which is discussed in detail below.

C) Methodology of Fiber Module Construction

For laboratory or commercial use, a suitable plurality of the pyrolyzed fibers is bundled together to form the membrane system 24. The number of fibers bundled together will depend on fiber diameters, lengths, and porosities and on desired throughput, equipment costs, and other engineering considerations understood by those in the chemical engineering arts.

The hollow fibers are arranged asymmetrically, i.e., the density of fibers at one side of the membrane is different from that at the opposite side, the density being greatest at the high-pressure side. For example, in the case of an asymmetric tubular hollow membrane, wherein the fluid flow is from a radially outer (high-pressure) side to a radially inner side, the carbon fibers should be more densely arranged at the outer side than at the inner side. Thus, the inner side would constitute a porous base layer which is contiguous with its dense outer layer.

If the membrane is formed in a cylindrical or tubular shape, the fibers are arranged parallel to a longitudinal axis of the cylinder. The radially inner, less-densely arranged, fibers can be mounted on an optional permeable cylindrical core 40 formed of a suitable rigid material.

Then, the fiber bundle is mounted in the housing 22 which, in turn, is mounted on the center tube 28 of the production string 13. Upper and lower ends of the outer periphery of the fiber bundle is situated within respective seals 42, 44, such that lower ends of the hollow fibers are closed, and upper ends of the hollow fibers are open.

Pressurized production fluid flowing upwardly through the center tube 28 exits that tube through the perforations formed therein and enters the membrane system 24 through the permeable core 40. As the mixture 26 flows around the fibers, the “fast” gases, such as CO₂, permeate through the individual fibers to the interior hollow bores of the fibers due to a pressure differential. This CO₂-enriched gas permeate 32 flows upwardly through the fibers and exits into a chamber 46 of the housing 22. The residual gas, i.e., the gas which does not permeate the fibers, such as methane, flows back into the center tube 28. This CO₂-depleted gas retentate 34 is conducted upwardly to the ground surface. The CO₂-enriched gas 32 is allowed to escape from the chamber 46 to the exterior of the housing 22 via an outlet 48 where it passes into the annulus 20. Alternatively, the Co₂-enriched gas 32 could be conducted to another membrane system for further purification before being discharged below the ground surface.

The separation process described above is not highly susceptible to fouling. Also, the membrane system 24 can be used at relatively high pressures. The carbon fibers themselves are highly resistant to the high temperatures found downhole. Thus, there is less of a tendency for the fibers to plasticize, even in the presence of a high CO₂ concentration.

The use of carbon fibers enables membranes to be produced that have a high degree of selectivity.

In order to perform permeation tests, for example, a test module consisting of a single CMS fiber is constructed, as shown in FIG. 3. Details of fabricating the module are given in the Illustrated Embodiments section below.

D) Operating Conditions

The process is operated with a feed pressure of from about 20 psia to about 4000 psia, preferably at least about 50 psia, and more preferably from about 200 psia to about 1000 psia. The feed temperature is its ambient temperature, e.g., its temperature as produced from the well.

### Illustrative Embodiments

The invention will be further clarified by the following Illustrative Embodiments, which are intended to be purely exemplary of the invention. The results are shown below.

A) Methodology of Formation of Carbon Membranes

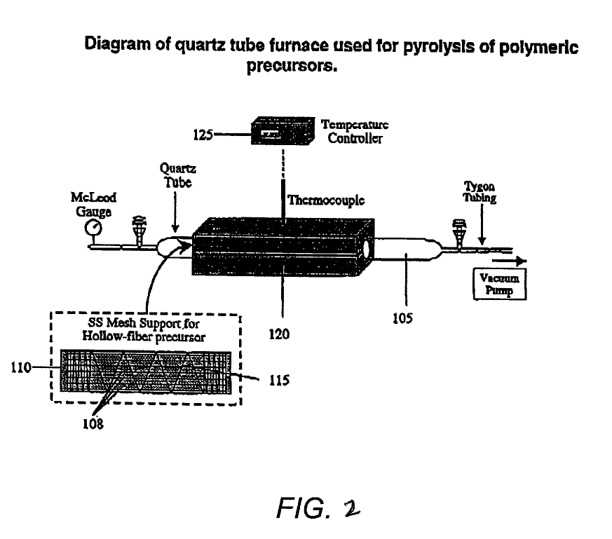

Reference is made to FIG. 2. The carbon membranes were produced by pyrolyzing hollow fiber polymeric materials in a quartz tube furnace 105. The polymeric fiber was a polyimide spun from a polymer solution through a conventional, commercially available spinneret. The polyimide was derived from a reaction of three monomers: 2,4,6 trimethyl 1,3phenylene diamine, 5,5 [2,2,2 trifluoro 1(trifluoromethyl)ethylidene] 1,3isobenzofurandion, and 3,3′,4,4′ biphenyl tetra carboxylic acid dianhydride. Its chemical structure was as previously shown. The membrane fibers were obtained from E. I. du Pont de Nemours and Company and L'Air Liquide S.A. The polymeric fibers had an outer diameter of 250 micron and an inner diameter of 160 micron.

Individual fibers 108 (36 to 37 cm in length) were placed on a piece of stainless steel mesh 110 (about 39 cm by 4.2 cm) and held in place by wrapping a length of bus wire 115 (24 AWG, soft bare copper) around the mesh and fibers. The mesh support 110 was 14 mesh, 0.020 woven. The mesh support 110 and fibers 108 were then placed in a quartz tube 105 of 2 inch diameter which sits in a 24 inch Thermcraft tube furnace 120. The tube 105 was centered so that the entire fiber length is within the effective heating zone. The system was evacuated until the pressure is 0.05 mm Hg or lower.

The heating cycle was controlled by temperature controller 125.

It was initiated with the following protocol (where SP=set point): start at SP0=50 C., then heated to SP1=250 C. at a rate of 13.3 C./min, then heated to SP2=535 C. at a rate of 3.85 C./min, then heated to SP3=550 C. at a rate of 0.25 C./min; the SP3=550 C. is maintained for 2 hours. After the heating cycle is complete, the system was allowed to cool under vacuum. The carbon membranes were removed once the system temperature drops below 40 C.

B) Methodology of Single Fiber Module Construction

Reference is made to FIG. 3. In order to perform permeation tests, a module 200 consisting of a single CMS fiber 205 was constructed. The module 200 is fabricated from two stainless steel (316) Swagelok ¼ inch tees 210, stainless steel ¼ inch tubing and nuts, two brass NPT ¼ inch female tube adapters 215, two brass NPT ¼ inch male tube adapters 220, and two brass Swagelok ¼ inch nuts. The hollow CMS fiber 205 is threaded through the module housing, so that a length of carbon fiber extends on each end. The ends of the module are then plugged with Stycast 2651 epoxy 225 (from Emerson & Cuming Company) cured for overnight. The ends of the CMS membrane 205 are snapped off after the epoxy hardens.

C) Methodology of Membrane Testing System

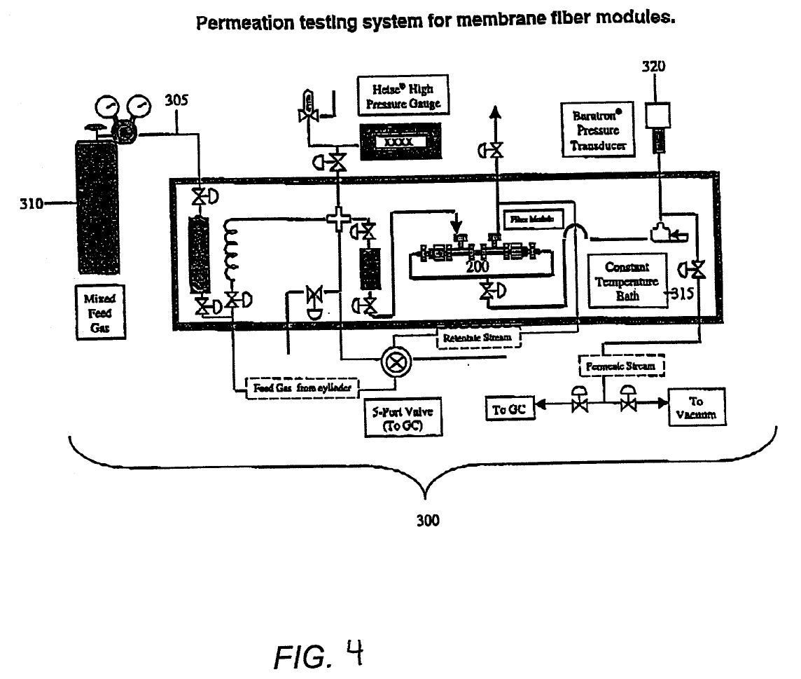

Reference is made to FIGS. 3 and 4. The permeation testing for the CMS fibers 205 was performed with single fiber test modules 200. Gas transport through the CMS membranes was examined with a pressure rise permeation testing system 300. The system permitted high pressure testing of mixed feed gas and sampling of gas streams with a gas chromatograph. The module 200 was attached in a shell feed method of operation. Mixed feed gas 305 from a compressed gas cylinder 310 was supplied on the shell side of a single fiber test module 200. The module 200 and ballast volumes were placed in a circulating water bath 315 to control and maintain a constant temperature.

Vacuum was pulled on both the shell side and bore side of the hollow fiber 205 first for overnight before testing. Permeate at the two ends from the bore side of the CMS fiber was pulled by vacuum through a downstream sample volume. The permeation rate was measured from the pressure rise of a Baratron pressure transducer 320 over time after closing the valve to vacuum. The pressure rise was plotted on chart recorder. The compositions of all the streams can be determined by a gas chromatograph. Individual gas fluxes were then calculated. The plumbing of the system consisted of stainless steel (316) Swagelok ¼ inch and ⅛ inch fittings and tubing, Whitey and Nupro valves with welded elements. The system is rated for over 1500 psia pressure.

### EXAMPLE 1

CMS hollow fibers were prepared as described in Sections A and B. Elemental analysis (electron spectroscopy for chemical analysis) indicated the presence of 95% atomic carbon and 5% atomic oxygen. Scanning electron micrographs (SEM) indicated an outer diameter of 150 to 170 micron and an inner diameter of 90 to 110 micron. The approximate mass loss is 30 to 35%. The approximate fiber length shrinkage was 10 to 25%.

Permeation tests were performed according to Section C above with mixed feed gas of 10% CO₂ and 90% CH₄ at three different temperatures (24° C., 35° C., 50° C.) and feed pressures up to 1000 psia. Results are shown in Table 1 below for the 200 to 1000 psia feed pressure range. Permeance is define as the pressure normalized flux of a given compound. The table includes CO₂ permeance (P_{CO2}/l) and the permeance ratio (P_{CO2}/P_{CH4}). The effective thickness, in the permeance is the same for both compounds. Both P_{CO2}/l and P_{CO2}/P_{CH4} decreased with increasing feed pressure, postulated (without intending to limit the scope of the invention) to be primarily due to gas phase non idealities (use of partial pressure driving force in the calculation of permeabilities, instead of partial fugacities) and a dual mode sorption effect.

| | P_{CO2}/l (10⁻⁶ cm³ (STP)/ | | | |
|---|---|---|---|---|
| | cm² · s · cm Hg) | | P_{CO2}/P_{CH4} | |
| Temperature (° C.) | 200 psia | 1000 psia | 200 psia | 1000 psia |
| 24 | 32 (±5) | 23 (±5) | 69 (±7) | 59 (±7) |
| 35 | 42 (±6) | 30 (±6) | 61 (±3) | 52 (±3) |
| 50 | 57 (±3) | 44 (±3) | 52 (±4) | 45 (±4) |

### EXAMPLE 2

CMS hollow fibers fabricated from Example 1 were subjected to experiments with toluene exposure for the 200 to 1000 psia feed pressure range. Permeation tests were performed according to Section C with mixed feed gas of 10% CO₂ and 90% CH₄ for two cases: (1) Case 1 containing a third component of 70.4 ppm toluene and (2) Case 2 containing a third component of 295 ppm toluene. Two temperatures were evaluated for each case: 35 C./ and 50 C. Results for Case 1 over the 200 to 1000 psia feed pressure range are shown in Table 2. Similar results were obtained for Case 2. Comparisons with the pre-exposure results for the same module indicate that CO₂ permeance (P_{CO2}/l) was reduced by approximately 15 to 20% for either toluene case, while the permeance ratio (P_{CO2}/P_{CH4}) remained approximately constant.

TABLE 2

| | P_{CO2}/l (10⁻⁶ cm³ (STP)/ | | | |
|---|---|---|---|---|
| | cm² · s · cm Hg) | | P_{CO2}/P_{CH4} | |
| Temperature (° C.) | 200 psia | 1000 psia | 200 psia | 1000 psia |
| 35 | 33 | 22 | 63 | 51 |
| 50 | 44 | 33 | 55 | 44 |

### EXAMPLE 3

CMS hollow fibers fabricated from Example 1 were subjected to experiments with n heptane exposure for the 200 to 1000 psia feed pressure range. Permeation tests were performed according to Section C with mixed feed gas of 10% CO₂ and 90% CH₄ for two cases: (1) Case 1 containing a third component of 100 ppm n heptane and (2) Case 2 containing a third component of 302 ppm n heptane. Two temperatures were evaluated for each case: 35 and 50 C. Results for Case 2 over the 200 to 1000.

psia feed pressure range are shown in Table 3. Similar results were obtained for Case 1. Comparisons with the virgin 10% CO₂/90% CH₄ results for the same module indicate that CO₂ permeance (P_{CO2}/l) was reduced by approximately 10 to 15% for either n heptane case, while the permeance ratio (P_{CO2}/P_{CH4}) remained approximately constant.

TABLE 3

| | P_{CO2}/l (10⁻⁶ cm³ (STP)/ | | | |
|---|---|---|---|---|
| | cm² · s · cm Hg) | | P_{CO2}/P_{CH4} | |
| Temperature (° C.) | 200 psia | 1000 psia | 200 psia | 1000 psia |
| 35 | 43 | 33 | 64 | 57 |
| 50 | 57 | 45 | 49 | 42 |

### EXAMPLE 4

A regeneration method was performed on the CMS hollow fibers from Examples 2 and 3 after experiments with toluene and n heptane exposure, respectively. The system (with module still connected) was depressurized back to atmospheric and purged with N₂ gas feed (extra dry grade) on the shell side (at a pressure of approximately 50 psia) with the retentate stream open for approximately 20 cm³/min of flow. With N₂ gas flowing, three heating stages were performed on the module in the water bath: 90 C. for approximately 7 hours, 50 C. for overnight for one day, and 35 C. for overnight for another day. After the overnight purges of N₂ gas, vacuum was pulled on the entire system (upstream and downstream) for overnight.

The permeation behavior of the CMS fiber was then examined again with 10% CO₂/90% CH₄ mixed feed gas (no organic vapor impurity). Results from the module exposed to 302 ppm n heptane after the regeneration method are shown in Table 4. Improvement in performance was observed for both temperatures. The P_{CO2}/l permeance was restored to approximately 90 to 95% of the virgin module performance prior to organic exposure with again no reduction in the P_{CO2}/P_{CH4} ratio.

Similar results were achieved for other modules exposed to organic vapor impurity and post treated with the above regeneration method. Typical performance recoveries ranged from 90% to 100% of the original performance prior to experiments with organic vapor impurities with no reduction in the P_{CO2}/P_{CH4} ratio.

TABLE 4

| | P_{CO2}/l (10⁻⁶ cm³ (STP)/ | | | |
|---|---|---|---|---|
| | cm² · s · cm Hg) | | P_{CO2}/P_{CH4} | |
| Temperature ° C. | 200 psia | 1000 psia | 200 psia | 1000 psia |
| 35 | 45 | 34 | 62 | 56 |
| 50 | 60 | 47 | 51 | 45 |

### Comparison Example A

A module consisting of aromatic polyimide hollow fibers and prepared in a similar fashion as described previously (with 50 fibers instead of a single fiber) was evaluated. Permeation tests were performed as described above with mixed feed gas of 10% CO₂ and 90% CH₄ at 50 C. and feed pressures up to 800 psia. The aromatic polyimide fibers broke at pressures greater than 850 psia. Results are shown in Table 5 below.

TABLE 5

| | P_{CO2}/l (10⁻⁶ cm³ (STP)/ | | | |
|---|---|---|---|---|
| | cm² · s · cm Hg) | | P_{CO2}/P_{CH4} | |
| Temperature (° C.) | 200 psia | 800 psia | 200 Psia | 800 psia |
| 50 | 18 | 15 | 17 | 20 |

### Comparative Example B

The module in Comparative Example A was evaluated for the two cases described in Example 2. Results indicated drastic losses to the P_{CO2}/P_{CH4} ratio due to the organic vapor impurities. Results for Case 1 (70.4 ppm toluene organic vapor impurity) over the 200 to 800 psia feed pressure range at 50 C. are shown in Table 6 below.

Comparisons with the pre exposure results for the same module indicated that CO₂ permeance (P_{CO2}/l) was reduced by approximately 5 to 25%, while the permeance ratio (P_{CO2}/P_{CH4}) was reduced by approximately 18 to 85%. The reductions in both the CO₂ permeance and P_{CO2}/P_{CH4} permeance ratio were most drastic at the higher pressure range. In contrast to our findings for the carbon membranes of the invention, the P_{CO2}/P_{CH4} permeance ratio for the aromatic polyimide fibers, in particular, was considerably reduced at high pressure.

In comparing these findings (for aromatic polyimide fibers), the robustness of the carbon membranes of the invention at high pressures and in the presence of organic vapor impurities is an important discovery.

TABLE 6

| | P_{CO2}/l (10⁻⁶ cm³ (STP)/ | | | |
|---|---|---|---|---|
| | cm² · s · cm Hg) | | P_{CO2}/P_{CH4} | |
| Temperature (° C.) | 200 psia | 800 psia | 200 psia | 800 psia |
| 50 | 17 | 11 | 14 | 3 |

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A process for the downhole separation of CO₂ from natural gas comprising the steps of:
(a) conducting a CO₂-containing natural gas within a production string including a downhole asymmetric filamentary carbon membrane system having an inside portion and an outside portion, the membrane system comprising a partial carbonization product of a hollow fiber, the fiber comprising an aromatic imide polymer material, the material comprising at least 90 weight percent carbon, the membrane system having a dense layer located in the outside portion of the membrane system and a porous base layer contiguous with the dense layer and located in the inside portion of the membrane system; and
(b) passing the CO₂-containing natural gas through the membrane system at a pressure of at least about 200 psia to cause said CO₂ to pass into the fiber interior and form a CO₂-enriched permeate therein, and a CO₂-depleted retentate outside of the fiber.

2. The process of claim 1, wherein the contacting in step (b) occurs at a pressure of at least about 500 psia.

3. The process of claim 1, wherein the contacting in step (b) occurs at a pressure of at least about 1000 psia.

4. The process of claim 1, wherein the carbon membrane system has a ratio of CO₂ permeability to natural gas permeability of at least about 30:1.

5. The process of claim 1, wherein the carbon membrane system has a ratio of CO₂ permeability to natural gas permeability of at least about 40:1.

6. The process of claim 1, wherein the carbon membrane system has a ratio of CO₂ permeability to natural gas permeability of at least about 50:1.

7. The process of claim 1, wherein said carbon membrane system comprising at least 95 weight percent carbon.

8. A process for the downhole separation of CO₂ from natural gas, comprising the steps of:
(a) conducting a CO₂-containing natural gas within a production string including a downhole cylindrical asymmetrical filamentary carbon membrane system comprising a partial carbonization product of a hollow fiber, the fiber comprising at least 90 weight percent carbon, the membrane system having a dense layer located in an outside portion of the membrane system and a porous base layer contiguous with the dense layer and located in an inside portion of the membrane system;
(b) passing the CO₂-containing natural gas at a pressure of at least 200 psia into a downhole housing in which the membrane system is mounted, whereby the CO₂-containing natural gas passes through the membrane system and forms a CO₂-enriched permeate within the fiber and a CO₂-depleted retentate outside of the fiber;
(c) discharging the CO₂-enriched permeate from the production string at a downhole location; and
(d) recovering the CO₂-depleted retentate.

9. The process of claim 8, wherein step (b) occurs at a pressure of at least about 500 psia.

10. The process of claim 8, wherein step (b) occurs at a pressure of at least about 1000 psia.

11. The process of claim 8, wherein the carbon membrane system has a ratio of CO₂ permeability to natural gas permeability of at least about 30:1.

12. The process of claim 8, wherein the carbon membrane system has a ratio of CO₂ permeability to natural gas permeability of at least about 40:1.

13. The process of claim 8, wherein the carbon membrane system has a ratio of CO₂ permeability to natural gas permeability of at least about 50:1.

14. The process of claim 8, wherein the carbon membrane system comprises at least 95 weight percent carbon.
